(19) United States
(12) Patent Application Publication
(10) Pub. No.: US 2022/0261887 A1
(43) Pub. Date: Aug. 18, 2022

(54) PROCESS AND METHOD FOR GENERATING VISUALIZATIONS BASED ON USER INPUTS ABOUT FINANCE AND EMOTIONS

(71) Applicant: Nav.it Inc., Seattle, WA (US)

(72) Inventors: Erin Papworth, Seattle, WA (US); Maia Monell, Sun Valley, ID (US); Kelley Hall, Seattle, WA (US); Darren Cox, Washington D.C., DC (US); Ilana Seidl, Miami, FL (US)

(21) Appl. No.: 17/671,507

(22) Filed: Feb. 14, 2022

Related U.S. Application Data
(60) Provisional application No. 63/149,017, filed on Feb. 12, 2021.

(51) Int. Cl. G06Q 40/02

(52) U.S. Cl. CPC G06Q 40/02

(57) ABSTRACT

The present invention is a process available on networked mobile applications that allows users to track self-reported emotional state alongside their historical financial data and provides the users with correlations of their emotional state with their financial habits. The application allows users to make positive changes to their financial habits based on a better understanding of those habits based on stress and emotional states.

### CROSS-REFERENCE TO RELATED APPLICATIONS

This application claims the benefit of U.S. Provisional Application Ser. No. 63/149,017, titled “A PROCESS AND METHOD FOR GENERATING VISUALIZATIONS BASED ON USER INPUTS ABOUT FINANCE AND EMOTIONS,” on Feb. 12, 2021. This application incorporates the entire contents of the foregoing application(s) herein by reference.

### TECHNICAL FIELD

Various embodiments relate generally to personal financial applications and the associated methods and processes for predicting and tracking financial habits based on self-reporting emotional well-being.

### BACKGROUND

People have a hard time budgeting and saving money. In fact, studies have shown that forty percent of Americans do not have the ability to pay for (and withstand the financial impact of) a $400 emergency. Furthermore, this lack of financial planning or resilience negatively impacts more women than men. This inability to cope with and recover from emergencies speaks to a person's financial resilience as much as, if not more than, a person's financial wealth or ability to budget. And this lack of resilience can effect a person even if they can afford a $400 emergency—with the rising costs of living and healthcare, having healthy finances becomes more important than ever. There are a plethora of financial applications out there, so why are people not more prepared? Why are people not more financially resilient?

Most financial applications are focused solely on the math of money in-money out. However, there are a multitude of factors that impact our spending including emotional well-being and personal history. The present invention provides a method and system for tracking historical, and self-reported, “moods” (or emotional well-being) of users and tracks that against spending patterns that are derived from aggregating existing financial accounts of the users. This data is then provided in various graphical forms, to ascertain whether factors such as the time of year or month, or emotional well-being, impacts financial well-being. This historical and self-reported information can then be used to predict and ascertain future behavior and spending patterns, potentially also helping users to avoid reckless or impulsive spending in favor of better habits.

### SUMMARY

Apparatus and associated methods relate to mobile devices with applications that can provide dynamic determination of the budget impact of a user's emotional well-being. Implemented in conjunction with this is a predictive budget tracking and creation system, where expenses are identified and then predicted for future short term and long term budget impact.

In an illustrative example, a person using a mobile device opens an application where they have connected their financial accounts. On an opening screen, the user may have various choices. One choice may be to view and take prescribed actions with financial accounts. Another choice may be to answer a questionnaire regarding their emotional well-being. The user will be prompted to explore more than one of the various choices while in the application.

Transactions and activity from financial accounts may be automatically imported into the application on a semi-regular basis, determined by the program, but at least daily. These transactions may be categorized by the user into several suggested or customized budget categories—where the budget categories reflect categories of spending. Alternatively, these transactions and activities may be automatically categorized into the suggested and/or customized budget categories. In illustrative examples where the transactions are automatically categorized, the user may have the option to review any automated categorization to correct or re-categorize the transactions according to their preference.

Where the user chooses to answer the questionnaire about their emotional state, the information is self-reported. Once the user answers the questions in the questionnaire, the user is presented with a report providing them with information about how they compare with others in their demographic. In some examples, the questionnaire may involve pictures, emojis, or gifs. Over time a dynamic report may be produced for the user, updated regularly, where they can view their transaction history as correlated with their emotional well-being. Findings may be reported to the user and other third parties about how emotional state impacts the user's budgeting and other financial decisions.

Third parties may find the data, in the aggregate and anonymized, to be useful for the purpose of targeting financial products or other products. Knowing general demographic data, the emotional state correlated with financial decision-making, and financial information may allow financial institutions to better gauge the suitability of lending products or financial products.

The details of various embodiments are set forth in the accompanying drawings and the description below. Other features and advantages will be apparent from the description and drawings, and from the claims.

### BRIEF DESCRIPTION OF THE DRAWINGS

FIG. 1 is a front view of a display screen or portion thereof of dynamic graphical user interface showing our new design;

FIG. 2 is a front view of a second image thereof;

FIG. 3 is a front view of a third image thereof;

FIG. 4 is a front view of a fourth image thereof; and

FIG. 5 is a front view of a fifth image thereof.

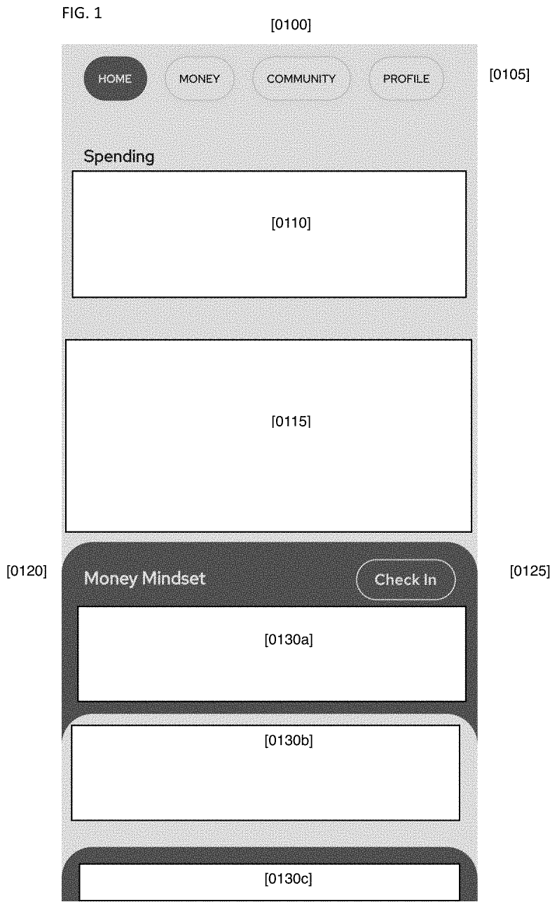

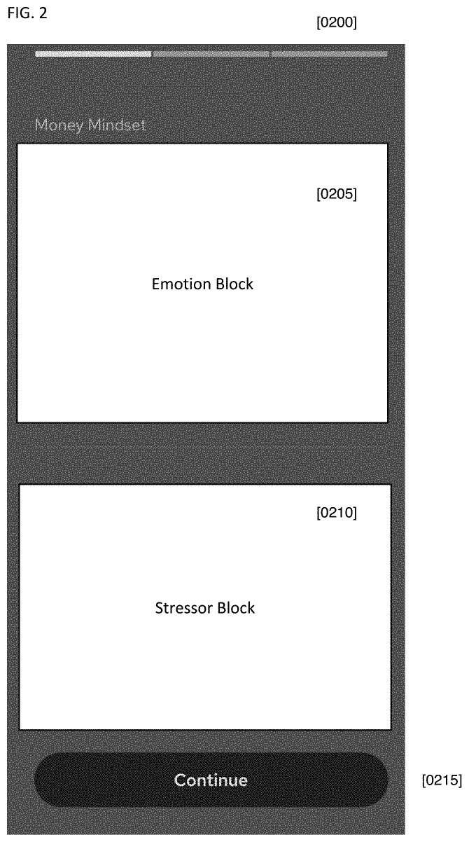

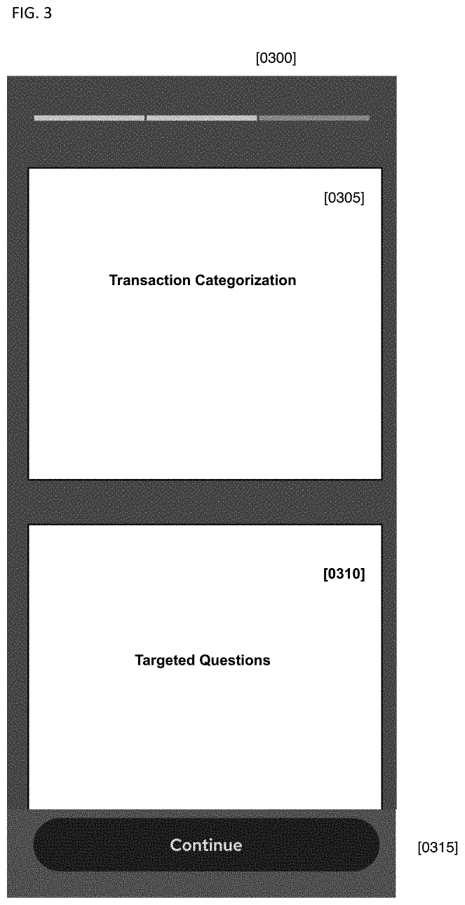

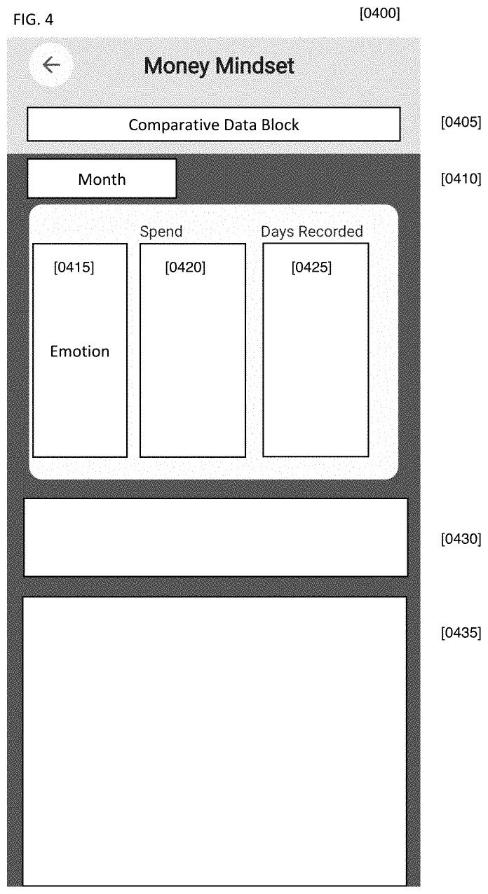

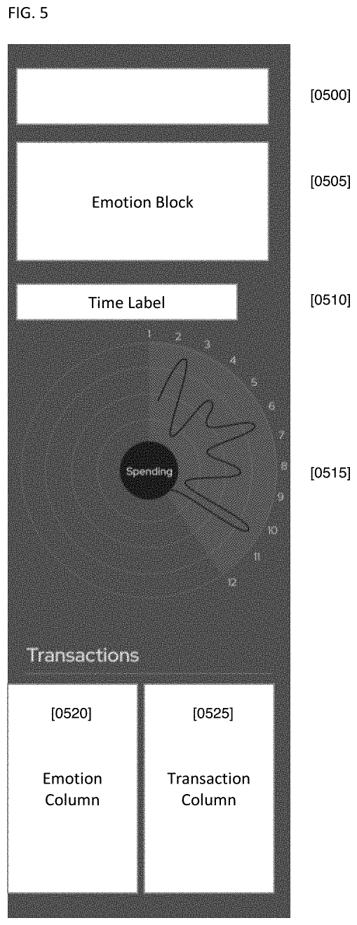

In accordance with the present disclosure, the appearance of the dynamic graphical user interface may transition from the image shown in FIG. 1 to the image shown in FIG. 2. The appearance of the dynamic graphical user interface transitions from the image shown in FIG. 2 to the image shown in FIG. 3. The appearance of the dynamic graphical user interface may transition from the image shown in FIG. 3 to the image shown in FIG. 4. The appearance of the dynamic graphical user interface may transition from the image shown in FIG. 4 to the image shown in FIG. 5.

### DETAILED DESCRIPTION OF ILLUSTRATIVE EMBODIMENTS

To aid understanding, this document is organized as follows. First, the FIGs are provided for illustrating an example of an interface on a mobile device that the user may interact with to receive the budget-related and financial reports and results created by the methods and processes claimed. The user may be encouraged to interact with more than one of the blocks while in the application. Second, with reference to the FIGs, the discussion turns to the exemplary embodiments that illustrate mobile devices with applications that can provide dynamic determination of the budget impact of a user's emotional well-being. Implemented in conjunction with this is a predictive budget tracking and creation system, where expenses are identified and then predicted for future short term and long term budget impact and how those expenses may fluctuate based on emotional well-being. Finally, with reference to the FIGs, further explanatory discussion and experimental data is presented to explain improvements in budget tracking and financial wellness applications.

In an illustrative example, a person using a mobile device opens an application where they have previously connected their financial accounts. FIG. 1 shows an example of an opening screen [0100], where the user may have various choices in the interactive blocks [0110] and [0115] and in interactive buttons [0105]. One interactive block may allow a user to view and take prescribed actions with financial accounts. Another interactive block [0120] may allow a user to enter a questionnaire using a button [0125] to self-report their emotional well-being. The emotional well-being block may show summaries [0130a-c] of previous entries and may provide the user with encouragement to provide repeated and regular entries of the questionnaire (to create “streaks”). These blocks allow users to interact with the application and encourage users to interact with the application, particularly the emotional well-being block, so that the application has larger datasets to provide the user with more specific and accurate reports.

Transactions and activity from financial accounts are automatically imported into the application on a semi-regular basis, determined by the program and user preference, but at least upon each login or opening of the application. These transactions may be categorized by the user into several suggested or customized budget categories—where the budget categories reflect categories of spending. Alternatively, these transactions and activities may be automatically categorized into the suggested and/or customized budget categories. In illustrative examples where the transactions are automatically categorized, the user may have the option to review any automated categorization to correct or re-categorize the transactions according to their preference. These transactions are used in reporting or summaries provided to the user, including being used in the background of the emotional well-being dashboard.

In a following screen [0200], after entering the self-reporting questionnaire [0125], the user may be asked several questions about their emotional state [0205] and life stressors (events affecting their stress levels) [0210]. At the bottom of the screen, the user will be asked to “continue” the questionnaire [0215].

In an illustrative embodiment, there may be a following screen [0300], where the user may be asked to match transactions with emotional state(s) [0305] and may be asked additional follow-up questions [0310]. At the bottom of the screen, the user will be asked to “continue” the questionnaire [0315].

In a final screen [0400], the user will be presented with several reports analyzing the data which the application has automatically gathered in the background as well as the data provided through the self-reported questionnaire. The first section of the screen [0405] may provide a chart for the previous or current month [0410]. In this section, the application may present the user with a comparison of emotions [0415] with quantification of spending correlated with the emotion [0420] and quantification of days feeling that emotion [0425]. Further reporting may be provided on the screen [0435] and [0440] further quantifying the self-reported data with the transaction history imported. The user may also receive typed words of encouragement or the celebration of “streaks” for repeated and regular interactions with the various interactive blocks in blocks [0435] or [0440]. The purpose of this is to collect regular and consistent data for the processes and methods to provide useful and detailed reporting to the user and any third party access of the data. The more often data is self-reported, the more accurate and more meaningful the reports are for the users and any third parties accessing the data. The questionnaire and the following screens allow the user to examine and determine spending and financial patterns related to their emotional well-being. This allows users to identify patterns and habits that they may or may not want to continue.

The final screen may include graphical representations of the user's historical data [0500]. The graphical representation may include summary or legend information [0505]. Followed by an interactive label that identifies the length of time for which the data is being displayed [0510]. Below, the graphical representation may be presented as a circular graph comparing emotions, spending, and time [0515]. Finally, a chart may be presented to the user where they are presented with a summary of spending [0525] correlated with emotions [0520] or highest transactions [0525] and self-reported emotions [0520]. All screens together in various configurations, provide the user with a way to assess their emotional well-being and how that affects their transaction history through the use of curated questions, gamification of the reporting of emotions, and automatedly importing transaction history.

Where the user chooses to answer the questionnaire about their emotional state, the information is self-reported. Once the user answers the questions in the questionnaire, the user is presented with a report providing them with information about how they compare with others in their demographic. In some examples, the questionnaire may involve pictures, emojis, or gifs. Over time a dynamic report may be produced for the user, updated regularly, where they can view their transaction history as correlated with their emotional well-being. In some examples, the application may suggest emotional states for the user when certain, repeated spending patterns are identified. Findings may be reported to the user and other third parties about how emotional state impacts the user's budgeting and other financial decisions.

In another illustrative embodiment, the application processes self-reported data and financial transactions from various sources to provide a user with insights into their past behavior and also predict future habits and behavior. Implemented in conjunction with a budget tracking system, the present invention may allow users to not only gain insight into their spending habits but also to make lasting changes to their spending patterns by identifying emotional triggers and not simply categorization of transactions.

What is claimed is:

1. A mobile application implemented process for emotion-oriented financial management using self-reported data and automatedly imported data through a series of dynamic graphical interfaces comprising:
providing, through execution of a networked mobile device including a processor, memory coupled to the processor, and a network connection mechanism coupled to the processor, the memory coupled to the processor having processor executable instructions stored therein to perform a process for emotion oriented financial management using self-reported data and automatedly imported data;
providing, through the memory coupled to the processor having processor executable instructions stored therein to access the network connection at semi-regular intervals, but at least when the mobile application is in use, to access and import historical financial transactions from at least one financial institution;
displaying, through at least one dynamic graphical interface, select financial transactions in chronological order followed by historical self-reported data, each in a graphical block;
defining, through a graphic, at least one button allowing for more specific interaction on various topics;
displaying, after interaction with a button, additional related dynamic graphical user interfaces grouped as a series to be interacted with in a specific order;
wherein, each graphical user interface in the series of related dynamic graphical interfaces, is further comprised of related interactive graphical blocks displaying questions to be answered;
creating, by the questions to be answered, a self-reported data set;
displaying, by the mobile application system, the historical financial transactions, and the self-reported data set, at least one chart with emotions and historical financial transactions;
creating, by the mobile application system, the historical financial transactions, and the self-reported data set, at least one graphic with historical emotion data and historical financial transactions;
wherein, at least one conclusion is presented based on the self-reported data set and historical financial transactions for aiding in financial management.

2. The mobile application implemented process from claim 1, where the questions to be answered are comprised of the subject of emotions.

3. The mobile application implemented process from claim 2, where the questions to be answered are further comprised of the subject of stress.

4. The mobile application implemented process from claim 3, where the conclusion is presented in a dynamic graph tracking time, historical financial data, and the self-reported data set.

5. The mobile application implemented process from claim 4, wherein, the conclusion based on the self-reported data set and historical financial transactions includes suggested habits to form.

6. The mobile application implemented process from claim 5, where the questions to be answered are represented through graphics.

7. The mobile application implemented process from claim 5, where the questions to be answered are represented through emoticons.
